(19) United States
(12) Patent Application Publication
(10) Pub. No.: US 2016/0187506 A1
(43) Pub. Date: Jun. 30, 2016

(54) METHOD FOR ITERATIVE INVERSION OF DATA FROM COMPOSITE SOURCES

(71) Applicant: CGG SERVICES SA, Massy (FR)

(72) Inventors: Andrew RATCLIFFE, Henfield (GB); Graham CONROY, Westerham (GB)

(21) Appl. No.: 14/908,759

(22) PCT Filed: Apr. 13, 2015
(86) PCT No.: PCT/IB2015/000794

§ 371 Date: Jan. 29, 2016

Related U.S. Application Data
(60) Provisional application No. 61/979,033, filed on Apr. 14, 2014.

(51) Int. Cl. G01V 1/28

(52) U.S. Cl. CPC G01V 1/282; G01V 2210/614; G01V 2210/679

(57) ABSTRACT

Iterative inversion of composite source data obtains recorded seismic data at a plurality of receivers from a plurality of sources. A selected orthogonal function is applied to a set of sources selected from the plurality of sources to identify candidate sources in the set of sources to receive a time shift. A time shift is applied only to the candidate sources, and all sources in the set of sources are combined into a composite source. A current earth model performs forward modeling for the composite source to generate a synthetic seismic data set. A composite recorded seismic data set associated with the set of sources at the receivers is determined and is used with the synthetic seismic data set to determine a residual seismic data set. The current earth model performs a gradient update that is used to update the current earth model and generate an updated earth model.

### CROSS REFERENCE TO RELATED APPLICATIONS

This application claims priority and benefit from U.S. Provisional Patent Application No. 61/979,033, filed Apr. 14, 2014, for “Method for Iterative Inversion of Data from Composite Sources”. The entire disclosure of which is incorporated in its entirety herein by reference.

### TECHNICAL FIELD

Embodiments of the subject matter disclosed herein generally relate to methods and systems for seismic data processing and, more particularly, to mechanisms and techniques for updating earth models using full waveform inversion.

### BACKGROUND

Full Waveform Inversion (FWI) updates an earth model by minimizing the difference between modeled and observed seismic data. The significant cost of computing the FWI remains a primary practical limitation, especially in industry applications. This significant cost is driven by determining the solution of the wave equation for every source in the acquired seismic data for a given earth model. This solution is repeated multiple times, because the earth model is updated in an iterative manner.

In general, a solution of the wave equation from the source is referred to as a “forward modeling”. Similarly, a solution of the wave equation from the receivers is referred to as a “reverse modeling”. An update to the current earth model is obtained by combining the forward and reverse modelings for a given source and receiver acquisition geometry to yield a “gradient” update to the current earth model, i.e., a direction in which to make a perturbation in the earth parameters of the earth model.

The typical workflow in a “sequential source” FWI implementation includes using the current earth model to perform an individual forward modeling for each source in a survey to generate a synthetic data set for each source. A difference is determined between each synthetic data set and a field data set of actual data at each given receiver in the set of receivers to produce a residual data set. A reverse modeling is then performed for the set of data residuals. This yields a “local” contribution to the gradient for the given source. This is repeated for each source. Not every source needs to be used in this update; however, the sources are modeled as individual entities. The “local” gradient contributions from each of these individual sources are combined to give the “total” gradient for this iteration. The “total” gradient is used to determine a direction of a perturbation in the earth parameters of the current earth model, and the current earth model is updated based on the “total” gradient.

These steps are performed iteratively for a given seismic bandpass frequency or frequency block. For example, these steps are repeated until convergence, or until a given maximum number of iterations is achieved. This iterative process to achieve convergence or to conduct a given maximum number of iterations are repeated at various seismic bandpass frequencies, updating the earth model as the process proceeds through the various seismic bandpass frequencies. Therefore, sequential source FWI implementation requires modeling for individual sources, in multiple iterations and multiple frequency blocks, resulting in high computational costs.

### SUMMARY

Exemplary embodiments are directed to systems and methods that reduce the overall computational cost, in both fixed receiver geometry arrangements and in arrangements of active receivers that move location for every source, by combining sources together while avoiding cross talk among the sources. This effectively reduces the number of sources and requires the calculation of fewer solutions to the wave equation. A plurality of sources are combined together, forming a composite or simultaneous source while avoiding unwanted cross talk among the individual sources that produces superfluous energy in the gradient that could contaminate the estimated earth model. Cross talk is reduced by staggering the firing time of the combined sources in a pre-determined manner.

To reduce the computational cost of FWI, the sources are combined prior to solving the wave equation. The quality of the estimated earth model is achieved by staggering the combined sources in time such that cross talk between sources is attenuated. Reducing the computational time of FWI makes FWI a faster process and facilitates pushing FWI to higher frequencies for the same computational cost.

In one exemplary embodiment, a method for iterative inversion of composite source data obtains recorded seismic data at a plurality of receivers from a plurality of sources. An orthogonal function is selected and applied to a set of sources selected from the plurality of sources to identify candidate sources in the set of sources to receive a time shift. In one embodiment, the set of sources includes all sources in the plurality of sources. In one embodiment, the orthogonal function is applied to the set of sources in accordance with a pre-defined order through the plurality of sources. Suitable pre-defined orders include, but are not limited to, selecting sources from the plurality of sources randomly, selecting sources from the plurality of sources in accordance with a regular two-dimensional spacing between adjacent selections, selecting every nth source in a sequence of sources comprising the plurality of sources where n comprises a whole number or selecting sources sequentially through the plurality of sources such that a next source selected comprises a maximum spatial distance away from all previously selected sources.

A time shift is applied only to the candidate sources in the set of sources, and all sources in the set of sources are combined into a composite source. In one embodiment, the time shift is a time shift forward in time. A current earth model is used to perform forward modeling for the composite source to generate a synthetic seismic data set. A composite recorded seismic data set associated with the set of sources at the receivers is determined and is used with the synthetic seismic data set to determine a residual seismic data set. In one embodiment, using the synthetic seismic data set and the composite recorded seismic data set to determine a residual seismic data set includes calculating a difference between the synthetic seismic data set and the composite recorded seismic data set. The current earth model is used to perform backward modeling for the residual seismic data and to generate a gradient update to the current earth model, which is used to update the current earth model in accordance to generate an updated earth model.

In one embodiment, the orthogonal function is a Walsh function, for example, a fixed set containing a series of +1 and −1 values. Application of this orthogonal function associates each source in the set of sources with either a +1 or a −1. The candidate sources associated with a −1 indicate applying a time shift to a selected source, and the candidate sources associated with a +1 in the Walsh function indicate applying no time shift.

In one embodiment, a current seismic bandpass frequency of the recorded seismic data is selected for iterative inversion. A constant time shift is applied corresponding to a lag of the maximum negative value in an autocorrelation of a source wavelet derived for recorded seismic data filtered in accordance with the current seismic bandpass frequency.

In one embodiment, the orthogonal function is applied to a plurality of sets of sources selected from the plurality of sources to identify candidate sources in each set of sources to receive a time shift, and the time shift is applied only to the candidate sources in each set of sources. The sources in each set of sources are combined to create a plurality of composite sources, and the current earth model is used to perform forward modeling for each one of the plurality of composite sources to generate a plurality of synthetic seismic data sets. A composite recorded seismic data set is determined for each one of the plurality of sets of sources at the receivers and is used with the plurality of synthetic seismic data sets to determine a plurality of residual seismic data sets. One residual seismic data set is determined for each one of the sets of sources.

The current earth model is used to perform backward modeling for each one of the plurality of residual seismic data sets to generate a plurality of gradient contributions, and the plurality of gradient contributions are combined to obtain the gradient update to the current earth model. In one embodiment, at least one source from the plurality of sources is contained in at least two sets of sources in the plurality of sets of sources. In one embodiment, combining the plurality of gradient contributions involves summing the plurality of gradient contributions.

In one embodiment, applying the orthogonal function to the set of sources further includes applying a plurality of orthogonal functions to the set of sources selected from the plurality of sources to identify a separate group of candidate sources to receive a time shift. Each separate group of candidate sources is associated with one of the orthogonal functions. A time shift is applied only to the candidate sources in each group of candidate sources, and the sources in the set of sources are combined to create a plurality of composite sources. Each composite source represents only one of the separate group of candidate sources associated with one of the plurality of orthogonal functions.

The current earth model is used to perform forward modeling for each one of the plurality of composite sources to generate a plurality of synthetic seismic data sets, and a composite recorded seismic data set is determined for each one of the plurality of sets of sources at the receivers. The plurality of synthetic seismic data sets and the plurality of composite recorded seismic data sets are used to determine a plurality of residual seismic data sets, one residual seismic data set for each one of the sets of sources, and the current earth model is used to perform backward modeling for each one of the plurality of residual seismic data sets to generate a plurality of gradient contributions. The plurality of gradient contributions is combined to obtain the gradient update to the current earth model.

Exemplary embodiments are directed to a method for iterative inversion of composite source data that obtains recorded seismic data at a plurality of receivers from a plurality of sources and iteratively updates a current earth model corresponding to the recorded seismic data by performing a plurality of iterations of the method for iterative inversion. This method for iterative inversion selects an orthogonal function and applies the orthogonal function to a set of sources selected from the plurality of sources to identify candidate sources in the set of sources to receive a time shift. A time shift is applied only to the candidate sources in the set of sources. All sources in the set of sources are combined into a composite source, and a current earth model to perform forward modeling for the composite source to generate a synthetic seismic data set. A composite recorded seismic data set associated with the set of sources at the receivers is determined and is used with the synthetic seismic data set to determine a residual seismic data set. The current earth model is used to perform backward modeling for the residual seismic data and to generate a gradient update to the current earth model. The current earth model is updated in accordance with the gradient update to generate an updated earth model. In this method, a new orthogonal function is selected for each iteration.

In one embodiment, a pre-determined number of iterations is selected, and the plurality of iterations are performed the pre-determined number of iterations. Alternatively, the plurality of iterations is performed until convergence of the updated earth model. In one embodiment, the current earth model corresponding to the recorded seismic data is iteratively updated for each one of a plurality of seismic bandpass frequencies. In one embodiment, a new Walsh function is selected for each iteration.

In one embodiment, a separate orthogonal function is applied to each one of a plurality of sets of sources selected from the plurality of sources to identify candidate sources in each set of sources to receive a time shift. The time shift is applied only to the candidate sources in each set of sources, and the sources in each set of sources are combined to create a plurality of composite sources. The current earth model is used to perform forward modeling for each one of the plurality of composite sources to generate a plurality of synthetic seismic data sets. A composite recorded seismic data set is determined for each one of the plurality of sets of sources at the receivers, and these are used with the plurality of synthetic seismic data sets to determine a plurality of residual seismic data sets, one residual seismic data set for each one of the sets of sources. The current earth model is used to perform backward modeling for each one of the plurality of residual seismic data sets to generate a plurality of gradient contributions. The plurality of gradient contributions is combined to obtain the gradient update to the current earth model. A new separate orthogonal function is selected for each one of the plurality of sets of sources for each iteration.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates an arrangement of seismic sources and seismic receivers in a fixed receiver geometry;

FIG. 2 is a flowchart of an embodiment of a method for composite source iterative inversion of seismic data in accordance with the present invention; and

FIG. 3 illustrates an exemplary data processing device or system which can be used to implement the methods.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to local activity taking place within the area of a seismic survey. However, the embodiments to be discussed next are not limited to this configuration, but may be extended to other arrangements that include regional activity, conventional seismic surveys, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

Exemplary embodiments reduce the computational cost of full waveform inversion (FWD. This reduction in computational cost is achieved while still maintaining the quality of the estimated earth model. The computational cost is reduced by combining the sources prior to solving the wave equation. Maintaining the quality of the estimated earth model is achieved by attenuating the cross talk between sources.

Reducing the computational time of FWI produces a large commercial advantage by making FWI a faster process and by allowing FWI to be pushed to higher frequencies for the same computational cost. The reduction in computational cost is achieved by reducing the total number of forward and reverse modelings compared to sequential source FWI, by combining together selected sets of sources to form one or more composite sources.

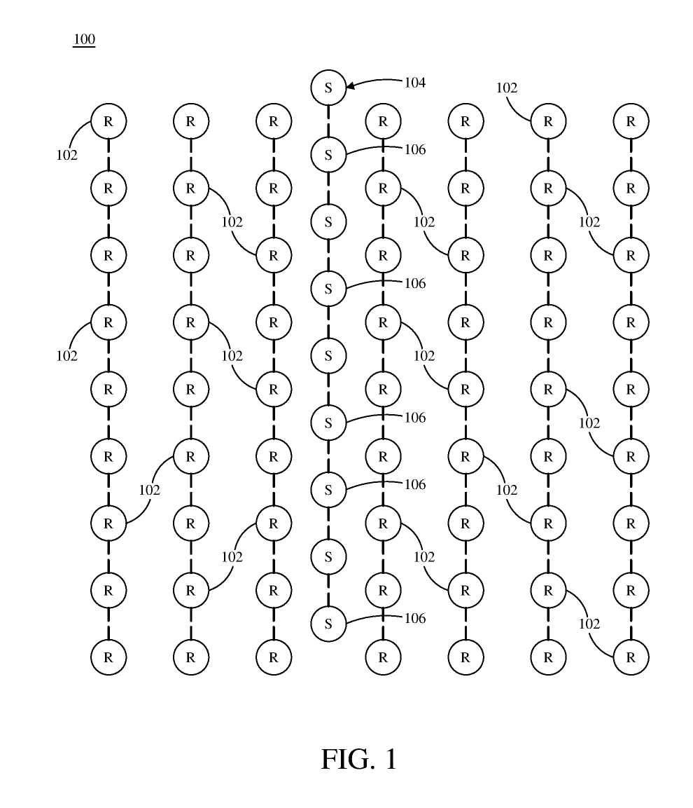

Referring initially to FIG. 1, an exemplary seismic data acquisition system 100 containing a plurality of receivers 102 and a plurality of sources 104 is illustrated. Suitable seismic data receivers and seismic data sources are known in the art. In one embodiment, the receivers are arranged in a fixed geometry, such as a grid. The receivers can be land-based ground equipment or marine-based systems, for example, ocean bottom nodes (OBN) that are deployed on the sea floor. In the fixed geometry, the location of each individual receiver is fixed. However, the actual number and arrangement of the receivers can vary and there can be variations in the spacing among the receivers in the fixed geometry grid. The plurality of sources represents a plurality of individual and separate sources or a plurality of source shots produced by one or more sources as those sources move along a line or path through or adjacent to the grid of receivers. Therefore, each source is the location of a source shot, having a known shot timing and location. While illustrated as a single line of sources, multiple lines of sources can be used as well as other geometrical arrangements of sources.

Exemplary embodiments perform an iterative inversion process, e.g., FWI, using a selected set 106 of the plurality of sources. This selected set can include the entire plurality of sources or a subset of the plurality of sources. The subset can be selected in a random order, a pseudo-random order or a regular order, e.g., every n^{th} source in a given line of sources. A given iterative inversion process, which includes a plurality of iterations, is conducted with respect to the selected set of sources and the plurality of receivers 102. In addition, a given iterative process can be conducted with respect to the selected frequency band in the recorded seismic data. The set of sources can be completely changed, i.e., a new set of sources is selected, using a different pseudo-random selection, or different regular selection, e.g., every (n+1)^{th} source, for each iteration. Alternatively, only a portion of the sources in a given set of sources is changed between iterations. Even when a complete new set of sources are randomly selected, individual sources can be selected for the new set of sources that were also contained in the previous set of sources.

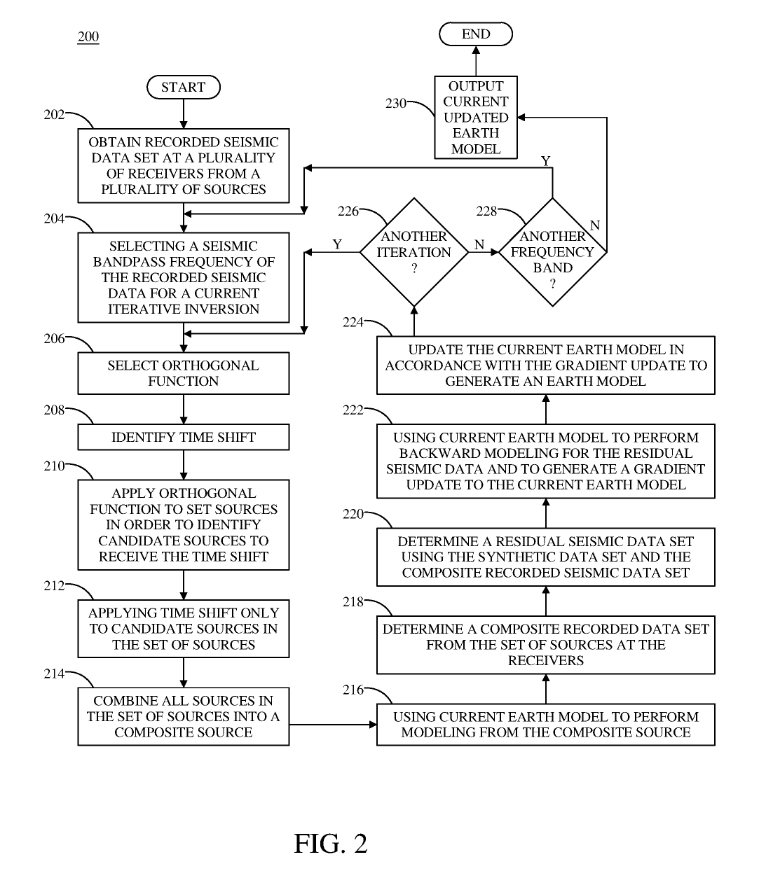

Referring to FIG. 2, an exemplary embodiment of a method for iterative inversion, e.g., FWI, of seismic data from composite sources 200 is illustrated. This method of iterative inversion is conducted for a given maximum number of iterations or until convergence is achieved at a selected seismic bandpass frequency, i.e., frequency band or frequency iteration “block”. The earth model is updated at each iteration in the iterative inversion process at the selected frequency band. Initially, a recorded seismic data set is obtained at a plurality of receivers from a plurality of sources 202. A current seismic bandpass frequency of the recorded seismic data for the current iterative inversion is selected 204. The current iterative inversion contains a plurality of iterations at this selected frequency band.

An orthogonal function is selected 206 for use with the current iteration. As used herein an orthogonal function refers to one function in a group or collection of orthogonal functions, where each function in that group is orthogonal to every other function in the group. Any suitable type of orthogonal function can be used. Preferably, these orthogonal functions are Walsh functions. Each Walsh function contains a fixed set of series of “+1's” or “−1's”.

As the orthogonal functions are used to determine sources within a given set of sources that are to receive a time shift, a desired time shift is identified 208. In one embodiment, the desired time shift is identified by filtering the source wavelet derived for the recorded seismic data set in accordance with the current selected seismic bandpass frequency and then performing an autocorrelation using the filtered source wavelet. In one embodiment, the lag corresponding to the maximum negative value in the autocorrelation is identified and used as the time shift. Preferably, the time shift is a constant time shift and is used for all sources that are to receive a time shift in a given iteration. As the size of the time shift is determined in accordance with the frequency band associated with the current iterative inversion process, the size of the constant time shift changes from one frequency band to the next. In one embodiment, the time shift from the autocorrelation of the wavelet is computed with the source and receiver ghosts present or not present, altering the magnitude of the time shift slightly.

The orthogonal function is applied to a set of sources selected from the plurality of sources to identify candidate sources in the set of sources to receive the time shift 210. In one embodiment, the set of sources includes the entire plurality of sources. Therefore, all available sources in the plurality of sources are used to construct the composite source used in the iterative inversion. Alternatively, the set of sources represents a subset of the entire plurality of sources. Preferably, the orthogonal function is applied to the set of sources selected from the plurality of sources in accordance with a pre-defined order through the plurality of sources.

Suitable methods and orders for applying the orthogonal function and selecting the sources in a set of sources include, but are not limited to selecting sources from the plurality of sources randomly, selecting sources from the plurality of sources in accordance with a regular two-dimensional spacing between adjacent selections, selecting every n^{th} source in a sequence of sources containing the plurality of sources where n is a whole number and selecting sources sequentially through the plurality of sources such that a next source selected in the series is located a maximum spatial distance away from all previously selected sources. In one embodiment, the set of sources includes the entire plurality of available source gathers, and any order of selection of the sources for application of the orthogonal function can be used.

When a given Walsh function is applied to a given set of sources in accordance with the pre-defined order, each source in that given set of sources is associated with a “+1” or a “−1”. In one embodiment, association with a “+1” in the Walsh function indicates applying no time shift, and association with a “−1” indicates applying a time shift to the selected source, or vice-versa. In one embodiment, the order of application of the series of “+1” and “−1” values of the Walsh function to the sources in the set of sources is in accordance with the pre-defined order of selection of the sources in a given set of sources as discussed above. Again, when the set of sources contains the entire plurality of the set of sources, the individual sources in the set of sources can be applied to the series of “+1” and “−1” values of the Walsh function in any order. Therefore, the values in the Walsh function are used to determine the candidate sources in a given set of sources that will receive the time shift.

Having identified the candidate sources in the set of sources to receive the time shift, the time shift is applied only to the candidate sources in the set of sources 212. In one embodiment, this time shift is a shift forward in time. Alternatively, this time shift is applied backward in time.

All of the sources in the set of sources, including the sources to which the time shift was applied and the sources to which no time shift was applied, are combined into a composite source 214. Combining the sources in the set of sources with a time shift is equivalent to a combined staggered firing of the sources in time. The result is a composite source constructed with one or more time shifted sources. The use of this function and the application of time shifts to selected sources attenuates cross talk among the sources in the iterative process, even when the set of sources includes the entire plurality of sources in the recorded seismic data set.

A current earth model corresponding to the area covered by the recorded seismic data is used to perform forward modeling for the composite source 216. This generates a synthetic seismic data set. A composite recorded seismic data set from the set of sources, i.e., from the composite source is determined at the receivers 218. The synthetic seismic data set and the composite recorded seismic data set are used to determine a residual seismic data set 220. In one embodiment, this residual seismic data set is determined by calculating a difference between the synthetic seismic data set and the composite recorded seismic data set. Alternative methods can also be used to compare the synthetic and recorded seismic data.

Having determined the residual seismic data set, the current earth model is used to perform backward modeling for the residual seismic data and to generate a gradient update to the current earth model 222. This gradient update is a direction of perturbation in one or more earth parameters within the current earth model. The current earth model is updated in accordance with the gradient update to generate an updated earth model 224. This updated earth model is then used as the current earth model in subsequent iterations. In one embodiment, methods can be used that do not require the use of a gradient for updating the earth model parameters, for example, a global inversion scheme.

A determination is made regarding whether another iteration is to be conducted for the current iterative inversion 226. If another iteration is desired, then a new orthogonal function is selected for the plurality of sources, or new set of sources selected from the plurality of sources, and the iterative inversion repeats to generate another updated earth model. In one embodiment, the same orthogonal function or Walsh function is used for all iterations in the current iterative inversion. Alternatively, a new orthogonal function or Walsh function is identified for each iteration. The iterative inversion process is repeated for a desired number of iterations. In one embodiment, this desired number of iterations is a predetermined number of iterations. Alternatively, the desired number of iterations is the number of iterations required until some convergence criterion is achieved.

If another iteration is not desired, then a determination is made regarding whether another frequency band is to be selected for a new iterative inversion process 228. If another frequency band is desired, a new current seismic bandpass frequency is selected, and the iterative inversion process is repeated for this frequency band. In general, the iterative inversion process is repeated for a plurality of seismic bandpass frequencies. In one embodiment, the same orthogonal function or Walsh function is used for the each iterative inversion at each frequency band. Alternatively, a new orthogonal function or Walsh function is identified for each iterative inversion at each frequency band. If a new frequency band is not to be selected, then the current updated earth model is output 230.

In addition to methods for using a single composite source, a plurality of composite sources can also be used in any given iteration of the iterative inversion process or during each iteration of the iterative inversion process. A plurality of composite sources can be generated by applying a single orthogonal function to the plurality of sources multiple times, for example, using different pre-defined orders. A plurality of sets of sources, selected from the plurality of sources, can also be selected in a given iteration. In another embodiment, a plurality of orthogonal functions is applied to the plurality of sources, and each orthogonal function selects and generates one of the plurality of sets of sources.

Selection of any given set of sources is separate from and independent of, or may be partially dependent on, the selection of other sets of sources. The resulting sets of sources can overlap partially or can be completely separate and independent sets in that the sets do not overlap and do not share common sources. As with the selection of a single set of sources, the plurality of sets of sources can be selected iteratively, changing with each iteration. Source selection can be made with or without replacements or using a hybrid scheme for partial replacement in the random source selection. In one embodiment, the selection of sources is not changed at every iteration but, for example, only at every other iteration, or only at the start of each new set of iterations when inverting a different frequency band. The same methods and orders for selection of any given set of sources are the same as those described above with respect to the selection of a single set of sources. In one embodiment, the composite sources are formed at the seismic data acquisition stage.

In one embodiment, a single orthogonal function or Walsh function is identified for application to each one of the plurality of sets of sources. Alternatively, a plurality of separate orthogonal or Walsh functions is identified, one for each set of sources. Each set in the plurality of sets of sources is applied to a given orthogonal function or Walsh function in accordance with a desired order to identify those candidate sources to which a time shift is to be applied and to form a corresponding composite source. This results in a plurality of composite sources, which can be referred to as realizations. Forward modeling is performed for each one of the plurality of composite sources or realizations to generate a plurality of synthetic seismic data sets. A composite recorded seismic data set is determined for each one of the plurality of sets of sources at the set of receivers. The plurality of synthetic seismic data sets and the plurality of composite recorded seismic data sets are used to determine a plurality of residual seismic data sets, one residual seismic data set for each one of the sets of sources.

The current earth model is then used to perform backward modeling for each one of the plurality of residual seismic data sets to generate a plurality of gradient contributions. These gradient contributions are combined to achieve the gradient update to the current earth model. In one embodiment, the gradient contributions are added together to create the gradient update. In another embodiment, a common signal portion is identified in each gradient contribution, and only these common signal portions are combined. This eliminates portions associated with noise.

In one embodiment, additional gradient estimates are generated for a current iteration using the same underlying individual source gathers or set of sources combined using a different orthogonal function or Walsh function in the identified plurality of orthogonal functions or Walsh functions. This yields a plurality of realizations and gradient contributions that are subsequently summed as described above to generate the gradient update to the current earth model. Therefore, a single set of sources, for example, a set containing the entire plurality of sources, is used to generate a plurality of realizations and gradient contributions.

In one embodiment, the composite source inversion process can be combined with sequential source FWI or with a generalized source FWI. Generalized sources are sources that have been combined such that they form a specific coherent shape of a wavefront, for example, a plane wave. These combinations use a mixture of the different techniques, either over a number of iterations, over sets of iterations or within the same iteration to obtain a set of different gradient estimates for combining. In one embodiment, reciprocity is used in order that the actual receivers are treated as computational sources, which is beneficial in terms of reducing computation cost, in cases such as when the source sampling is denser than the receiver sampling. In one embodiment, the recorded seismic data set may be interpolated, using a suitable multi-dimensional interpolation algorithm, onto a plurality of new source and/or receiver positions; the resulting interpolated data, and corresponding interpolated source and/or receiver positions, subsequently being used in the composite source inversion process.

Methods and systems in accordance with exemplary embodiments can be hardware embodiments, software embodiments or a combination of hardware and software embodiments. In one embodiment, the methods described herein are implemented as software. Suitable software embodiments include, but are not limited to, firmware, resident software and microcode. In addition, exemplary methods and systems can take the form of a computer program product accessible from a computer-usable or computer-readable medium providing program code for use by or in connection with a computer, logical processing unit or any instruction execution system. In one embodiment, a machine-readable or computer-readable medium contains a machine-executable or computer-executable code that when read by a machine or computer causes the machine or computer to perform method for iterative inversion of composite source data in accordance with exemplary embodiments and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages.

As used herein, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums and include non-transitory computer-readable mediums. Suitable computer-readable mediums include, but are not limited to, a semiconductor or solid state memory, magnetic tape, a removable computer diskette, a random access memory (RAM), a read-only memory (ROM), a rigid magnetic disk and an optical disk. Suitable optical disks include, but are not limited to, a compact disk-read only memory (CD-ROM), a compact disk-read/write (CD-R/W) and DVD.

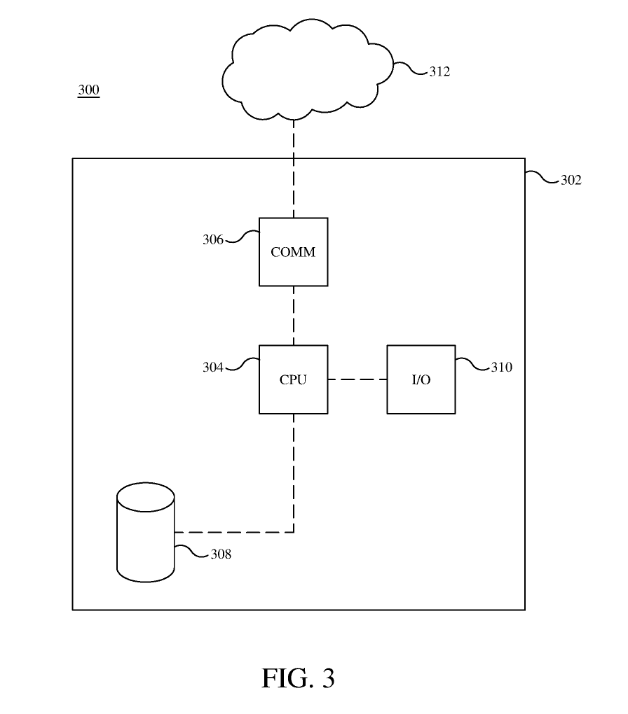

In one embodiment, a computing device for performing the calculations as set forth in the above-described embodiments may be any type of computing device capable of processing and communicating seismic data associated with a seismic survey. An example of a representative computing system capable of carrying out operations in accordance with these embodiments is illustrated in FIG. 3. The computing system 300 includes a computer or server 302 having one or more central processing units 304 in communication with a communication module 306, one or more input/output devices 310 and at least one storage device 308. All of these components are known to those of ordinary skill in the art, and this description includes all known and future variants of these types of devices. The communication module provides for communication with other computing systems, databases and data acquisition systems across one or more local or wide area networks 312. This includes both wired and wireless communication. Suitable input-output devices include keyboards, point and click type devices, audio devices, optical media devices and visual displays.

Suitable storage devices include magnetic media such as a hard disk drive (HDD), solid state memory devices including flash drives, ROM and RAM and optical media. The storage device can contain data as well as software code for executing the functions of the computing system and the functions in accordance with the methods described herein. Therefore, the computing system 300 can be used to implement the methods described above associated with the calculation of the induced source shot gather. Hardware, firmware, software or a combination thereof may be used to perform the various steps and operations described herein.

The disclosed exemplary embodiments provide a computing device, software and method for iterative inversion of composite source data. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software, or firmware tangibly embodied in a computer-readable storage medium for execution by a geo-physics dedicated computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for iterative inversion of composite source data, the method comprising:
obtaining recorded seismic data at a plurality of receivers from a plurality of sources;
selecting an orthogonal function;
applying the orthogonal function to a set of sources selected from the plurality of sources to identify candidate sources in the set of sources to receive a time shift;
applying a time shift only to the candidate sources in the set of sources;
combining all sources in the set of sources into a composite source;
using a current earth model to perform forward modeling for the composite source to generate a synthetic seismic data set;
determining a composite recorded seismic data set associated with the set of sources at the receiver;
using the synthetic seismic data set and the composite recorded seismic data set to determine a residual seismic data set;
using the current earth model to perform backward modeling for the residual seismic data and to generate a gradient update to the current earth model; and
updating the current earth model in accordance with the gradient update to generate an updated earth model.

2. The method of claim 1, wherein applying the orthogonal function comprises applying the orthogonal function to the set of sources in accordance with a pre-defined order through the plurality of sources.

3. The method of claim 2, wherein the pre-defined order comprises selecting sources from the plurality of sources randomly, selecting sources from the plurality of sources in accordance with a regular two-dimensional spacing between adjacent selections, selecting every n^{th} source in a sequence of sources comprising the plurality of sources where n comprises a whole number or selecting sources sequentially through the plurality of sources such that a next source selected comprises a maximum spatial distance away from all previously selected sources.

4. The method of claim 1, wherein the set of sources comprises all sources in the plurality of sources.

5. The method of claim 1, wherein selecting the orthogonal function comprises selecting a Walsh function.

6. The method of claim 5, wherein:
the Walsh function comprises a fixed set comprising a series of +1 and −1 values; and
applying the orthogonal function comprises associating each source in the set of sources with either a +1 or a −1, the candidate sources associated with a −1 indicating applying a time shift to a selected source and the candidate sources associated with a +1 in the Walsh function indicating applying no time shift.

7. The method of claim 1, wherein applying the time shift comprises applying a time shift forward in time.

8. The method of claim 1, wherein the method further comprises:
selecting a current seismic bandpass frequency of the recorded seismic data for iterative inversion; and
applying a time shift further comprises applying a constant time shift corresponding to a lag of the maximum negative value in an autocorrelation of a source wavelet derived for recorded seismic data filtered in accordance with the current seismic bandpass frequency.

9. The method of claim 1, wherein using the synthetic seismic data set and the composite recorded seismic data set to determine a residual seismic data set comprises calculating a difference between the synthetic seismic data set and the composite recorded seismic data set.

10. The method of claim 1, wherein:
applying the orthogonal function to the set of sources further comprises applying the orthogonal function to a plurality of sets of sources selected from the plurality of sources to identify candidate sources in each set of sources to receive a time shift;
applying the time shift further comprises applying the time shift only to the candidate sources in each set of sources;
combining the set of sources further comprises combining each set of sources to create a plurality of composite sources;
using the current earth model to perform forward modeling further comprises using the current earth model to perform forward modeling for each one of the plurality of composite sources to generate a plurality of synthetic seismic data sets;
determining the composite recorded seismic data set further comprises determining a composite recorded seismic data set for each one of the plurality of sets of sources at the receivers;
using the synthetic seismic data set and the composite recorded seismic data set to determine a residual seismic data set further comprises using the plurality of synthetic seismic data sets and the plurality of composite recorded seismic data sets to determine a plurality of residual seismic data sets, one residual seismic data set for each one of the sets of sources; and
using the current earth model to perform backward modeling further comprises using the current earth model to perform backward modeling for each one of the plurality of residual seismic data sets to generate a plurality of gradient contributions and combining the plurality of gradient contributions to obtain the gradient update to the current earth model.

11. The method of claim 10, wherein at least one source from the plurality of sources is contained in at least two sets of sources in the plurality of sets of sources.

12. The method of claim 10, wherein combining the plurality of gradient contributions comprises summing the plurality of gradient contributions.

13. The method of claim 1, wherein:
applying the orthogonal function to the set of sources further comprises applying a plurality of orthogonal functions to the set of sources selected from the plurality of sources to identify a separate group of candidate sources to receive a time shift, each separate group of candidate sources associated with one of the orthogonal functions;
applying a time shift further comprises applying the time shift only to the candidate sources in each group of candidate sources;
combining the set of sources further comprises combining the set of sources to create a plurality of composite sources, each composite source comprises only one of the separate group of candidate sources associated with one of the plurality of orthogonal functions;
using the current earth model to perform forward modeling further comprises using the current earth model to perform forward modeling for each one of the plurality of composite sources to generate a plurality of synthetic seismic data sets;
determining the composite recorded seismic data set further comprises determining a composite recorded seismic data set for each one of the plurality of sets of sources at the receivers;
using the synthetic seismic data set and the composite recorded seismic data set to determine a residual seismic data set further comprises using the plurality of synthetic seismic data sets and the plurality of composite recorded seismic data sets to determine a plurality of residual seismic data sets, one residual seismic data set for each one of the sets of sources; and
using the current earth model to perform backward modeling further comprises using the current earth model to perform backward modeling for each one of the plurality of residual seismic data sets to generate a plurality of gradient contributions and combining the plurality of gradient contributions to obtain the gradient update to the current earth model.

14. A method for iterative inversion of composite source data, the method comprising:
obtaining recorded seismic data at a plurality of receivers from a plurality of sources; and
iteratively updating a current earth model corresponding to the recorded seismic data by performing a plurality of iterations of the following steps:
selecting an orthogonal function;
applying the orthogonal function to a set of sources selected from the plurality of sources to identify candidate sources in the set of sources to receive a time shift;
applying a time shift only to the candidate sources in the set of sources;
combining all sources in the set of sources into a composite source;
using a current earth model to perform forward modeling for the composite source to generate a synthetic seismic data set;
determining a composite recorded seismic data set associated with the set of sources at the receivers;
using the synthetic seismic data set and the composite recorded seismic data set to determine a residual seismic data set;
using the current earth model to perform backward modeling for the residual seismic data and to generate a gradient update to the current earth model; and
updating the current earth model in accordance with the gradient update to generate an updated earth model;
wherein a new orthogonal function is selected for each iteration.

15. The method of claim 14, wherein:
the method further comprises selecting a pre-determined number of iterations; and
performing the plurality of iterations comprises performing the pre-determined number of iterations.

16. The method of claim 14, wherein performing the plurality of iterations comprises performing the plurality of iterations until convergence of the updated earth model.

17. The method of claim 14, wherein the method further comprises iteratively updating the current earth model corresponding to the recorded seismic data for each one of a plurality of seismic bandpass frequencies.

18. The method of claim 14, wherein selecting the orthogonal function further comprises selecting a Walsh function for each iteration.

19. The method of claim 14, wherein:
applying the orthogonal function to the set of sources further comprises applying a separate orthogonal function to each one of a plurality of sets of sources selected from the plurality of sources to identify candidate sources in each set of sources to receive a time shift;
applying the time shift further comprises applying the time shift only to the candidate sources in each set of sources;
combining the set of sources further comprises combining each set of sources to create a plurality of composite sources;
using the current earth model to perform forward modeling further comprises using the current earth model to perform forward modeling for each one of the plurality of composite sources to generate a plurality of synthetic seismic data sets;
determining the composite recorded seismic data set further comprises determining a composite recorded seismic data set for each one of the plurality of sets of sources at the receivers;
using the synthetic seismic data set and the composite recorded seismic data set to determine a residual seismic data set further comprises using the plurality of synthetic seismic data sets and the plurality of composite recorded seismic data sets to determine a plurality of residual seismic data sets, one residual seismic data set for each one of the sets of sources; and
using the current earth model to perform backward modeling further comprises using the current earth model to perform backward modeling for each one of the plurality of residual seismic data sets to generate a plurality of gradient contributions and combining the plurality of gradient contributions to obtain the gradient update to the current earth model;
wherein a new separate orthogonal function is selected for each one of the plurality of sets of sources for each iteration.

20. A computer-readable storage medium containing a computer-readable code that when read by a computer causes the computer to perform a method for iterative inversion of composite source data, the method comprising:
obtaining recorded seismic data at a plurality of receivers from a plurality of sources;
selecting an orthogonal function;
applying the orthogonal function to a set of sources selected from the plurality of sources to identify candidate sources in the set of sources to receive a time shift;
applying a time shift only to the candidate sources in the set of sources;
combining all sources in the set of sources into a composite source;
using a current earth model to perform forward modeling for the composite source to generate a synthetic seismic data set;
determining a composite recorded seismic data set associated with the set of sources at the receivers;
using the synthetic seismic data set and the composite recorded seismic data set to determine a residual seismic data set;
using the current earth model to perform backward modeling for the residual seismic data and to generate a gradient update to the current earth model; and
updating the current earth model in accordance with the gradient update to generate an updated earth model.
